(19) United States
(12) Patent Application Publication
(10) Pub. No.: US 2019/0086847 A1
(43) Pub. Date: Mar. 21, 2019

(54) FIXING DEVICE

(71) Applicant: CANON KABUSHIKI KAISHA, Tokyo (JP)

(72) Inventors: Masaki Tanaka, Kawasaki-shi (JP); Masafumi Maeda, Yokohama-shi (JP)

(21) Appl. No.: 16/136,383

(22) Filed: Sep. 20, 2018

(30) Foreign Application Priority Data
Sep. 21, 2017 (JP) 2017-181186
Aug. 1, 2018 (JP) 2018-144753

(51) Int. Cl. G03G 15/20

(52) U.S. Cl. CPC G03G 15/2057

(57) ABSTRACT

A fixing device includes a frame, a component part, a cylindrical film, a supporting portion, and a roller. The supporting portion includes a first opposing surface opposing an inner surface of the film at the longitudinal end portion of the film and a second opposing surface opposing the inner surface of the film on an inside of the first opposing surface with respect to a longitudinal direction of the film. Each of the first and second opposing surfaces is a surface forming a substantially right angle with an engaging surface of the component part. When the component part is seen in the longitudinal direction of the film, a contour of the first opposing surface is larger than a contour of the second opposing surface.

### FIELD OF THE INVENTION AND RELATED ART

The present invention relates to a fixing device mountable to an image forming apparatus such as an electrophotographic copying machine or an electrophotographic printer.

As the fixing device mounted in the copying machine or printer of an electrophotographic type, a fixing device of a film heating type has been known. The fixing device of this type includes a rotatable cylindrical film, a plate-like heater contacting an inner peripheral surface of the film, and a pressing roller for forming a nip in cooperation with the heater through the film. A recording material on which an unfixed toner image is carried is heated while being fed through the nip, whereby the toner image is fixed on the recording material.

In the fixing device of the film heating type, with respect to a longitudinal direction of the film perpendicular to a recording material feeding direction, in some cases, due to a component tolerance and an assembly tolerance in manufacturing of the device, a deviation in parallelism of the pressing roller and the film and localization of a pressure distribution of the nip generate. In that case, a force for moving the film in a film longitudinal direction (hereinafter, this force is referred to as a film shifting force) acts, so that a shift of the film in the film longitudinal direction generates.

Therefore, in a fixing device disclosed in Japanese Patent No. 3814542, a regulating (limiting) member opposing a film end portion is provided, and when the shift of the film generates, the film end portion is received by a regulating (limiting) portion of the regulating member. The regulating portion is provided with a surface having an inner diameter gradually decreasing toward an outside thereof with respect to the film longitudinal direction, and by the surface, breakage of the film end portion is suppressed.

In the fixing device of the film heating type, it has been required that the breakage of the film end portion is suppressed by reducing the film shifting force.

### SUMMARY OF THE INVENTION

A principal object of the present invention is to provide a fixing device capable of reducing a shifting force of a cylindrical film and capable of suppressing breakage of a film end portion.

According to an aspect of the present invention, there is provided a fixing device for fixing an image, formed on a recording material, on the recording material, the fixing device comprising: a frame; a component part engaging with the frame; a cylindrical film rotatable while being contactable to the recording material; a supporting portion provided in an inside space of the film at a position opposing a longitudinal end portion of the film, the supporting portion being provided as a part of the component part; and a roller contacting an outer peripheral surface of the film and configured to form a nip, in which the recording material is nipped and fed, between itself and the film, wherein the supporting portion includes a first opposing surface opposing an inner surface of the film at the longitudinal end portion of the film and a second opposing surface opposing the inner surface of the film on an inside of the first opposing surface with respect to a longitudinal direction of the film, wherein each of the first opposing surface and the second opposing surface is a surface forming a substantially right angle with an engaging surface which is a surface where the component part engages with the frame and where the component part opposes a flat surface portion of the frame, and wherein when the component part is seen in the longitudinal direction of the film, a contour of the first opposing surface is larger than a contour of the second opposing surface.

Further features of the present invention will become apparent from the following description of exemplary embodiments with reference to the attached drawings.

### BRIEF DESCRIPTION OF THE DRAWINGS

FIG. 1 is a perspective view showing a schematic structure of a fixing device according to Embodiment 1.

FIG. 2 is a sectional view showing the schematic structure of the fixing device according to Embodiment 1.

FIG. 3 is a perspective view showing a right-side flange of FIG. 1.

FIG. 4 is a perspective view when the right-side flange of FIG. 1 and a right-side end portion of a film supported by a supporting portion of this flange are seen from an upstream side of a recording material feeding direction.

FIG. 5 is a schematic view showing a positional relationship between the supporting portion of the right-side flange of FIG. 1 and the film regulated in rotation orbit by the supporting portion.

FIG. 6 is a schematic view showing a relationship between a length of the film and a distance between regulating portions of left and right flanges.

FIG. 7 shows a state when the film shifts in a film longitudinal direction.

Parts (a) and (b) of FIG. 8 are schematic views for illustrating a first opposing surface and a second opposing surface of the flange.

FIG. 9 is a schematic view showing the film and the left and right flanges each provided with the first opposing surface and the second opposing surface on the upstream side of the recording material feeding direction.

FIG. 10 is a schematic view showing the film and the left and right flanges each provided with the first opposing surface and the second opposing surface on a downstream side of the recording material feeding direction.

Parts (a) and (b) of FIG. 11 are schematic views for illustrating a first opposing surface and a second opposing surface of a flange of a fixing device according to Embodiment 2.

FIG. 12 is a perspective view showing the flange of FIG. 11.

Parts (a) and (b) of FIG. 13 are schematic views for illustrating a first opposing surface and a second opposing surface of a flange of a fixing device according to Embodiment 3.

FIG. 14 is a perspective view showing the flange of FIG. 13.

FIG. 15 is a sectional view showing a schematic structure of an image forming apparatus.

FIG. 16 is a schematic view for illustrating angles of opposing surfaces.

### DESCRIPTION OF EMBODIMENTS

Embodiments of the present invention will be described with reference to the drawings. Although these embodiments are preferred embodiments of the present invention, the present invention is not limited to the following embodiments, but various constitutions thereof can be replaced with other various known constitutions within a scope of a concept of the present invention.

### Embodiment 1

### (1) Image Forming Apparatus 20

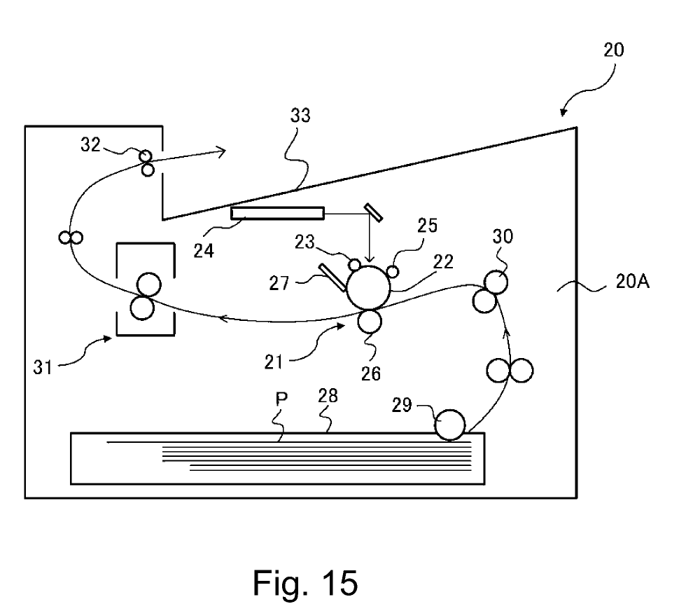

With reference to FIG. 15, an image forming apparatus 20 in which a fixing device according to the present invention is mounted will be described. FIG. 15 is a sectional view showing a general structure of an example of the image forming apparatus (a monochromatic printer in this embodiment) 20 using an electrophotographic recording technique.

In the image forming apparatus 20, an image forming portion 21 for forming an image on a recording material includes a photosensitive drum 22, a charging member 23, a laser scanner 24, a developing device 25, a transfer member 26 and a cleaner 27 for cleaning an outer peripheral surface of the photosensitive drum 22. An operation of the image forming portion 1 is well known, and therefore, will be omitted from detailed description.

A recording material P accommodated in a cassette 28 in an apparatus main assembly 20A is fed one by one by rotation of a roller 29. Then, the recording material P is fed to a transfer portion, formed by the photosensitive drum 22 and the transfer member 26, by rotation of a roller pair 30. The recording material P on which the toner image is transferred at the transfer portion is sent to a fixing device (fixing portion) 31, and the toner image is heat-fixed on the recording material P by the fixing device 31. The recording material P coming out of the fixing device 31 is discharged onto a tray 33 by rotation of a roller pair 32.

(2) Fixing device 31

### (2-1) Device Structure

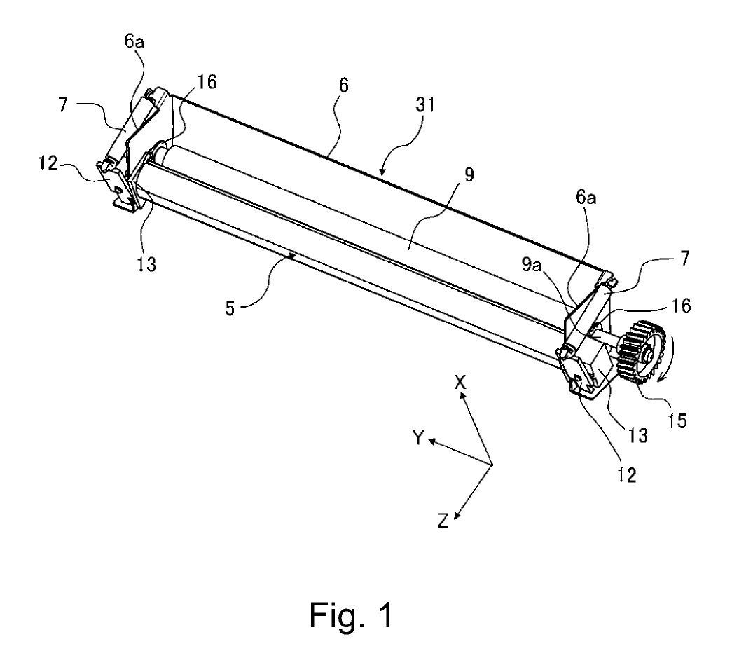

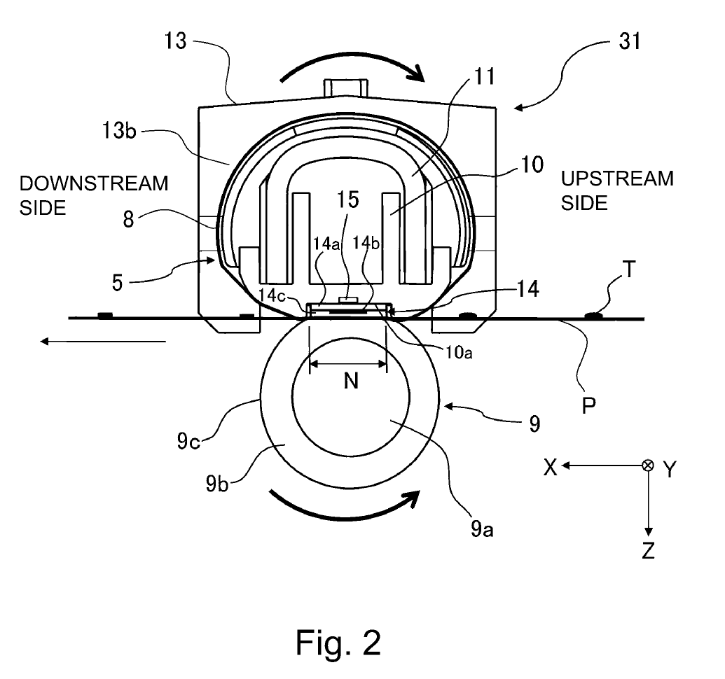

The fixing device 31 in this embodiment is a fixing device of a film heating type. The fixing device 31 will be described with reference to FIGS. 1 and 2. FIG. 1 is a perspective view showing a schematic structure of an entirety of the fixing device 31. FIG. 2 is a sectional view showing the schematic structure of the fixing device 31. In FIGS. 1 and 2, X is a recording material feeding direction, Y is a longitudinal direction of the fixing device 31 (film 8) perpendicular to the recording material feeding direction X, and Z is a recording material thickness direction.

The fixing device 31 includes a heating unit 5, a pressing roller 9 as a rotatable heating member, left and right flanges 13 as regulating (limiting) members, and a frame 6 for supporting the heating unit 5, the pressing roller 9 and the flanges 13. In this embodiment, each of the flanges 13 corresponds to a component part engaging with the frame 6.

As shown in FIG. 2, the pressing roller 9 includes a core metal 9a, an elastic layer 9b formed on an outer peripheral surface of the core metal 9a and consisting of a silicone rubber, a fluorine-containing rubber or the like, and a parting layer 9c formed on an outer peripheral surface of the elastic layer 9b and consisting of PFA, PTFE or the like. Here, PFA is tetrafluoroethylene-perfluoroalkylvinyl ether copolymer, and PTFE is polytetrafluoroethylene.

As regards the pressing roller 9, as shown in FIG. 1, both end portions of the core metal 9a are rotatably supported by left and right side plates 6a of the frame 6 through bearing members 16 with respect to the direction Y.

As shown in FIG. 2, the heating unit 5 includes a rotatable cylindrical film 8, a plate-like heater 14 as a heating member, a holder 10 as a supporting member for supporting the heater 14, and a stay 11 as a pressing member.

The holder 10 formed of a heat-resistant resin material supports the heater 14 at a recessed portion 10a provided along the direction Y on a flat surface thereof on the pressing roller 9 side. On a flat surface of the holder 10 on a side opposite from the pressing roller 9 side, the stay 11 formed of metal or a heat-resistant resin material is provided. The stay 11 is formed in a U-shape in cross-section in order to reinforce the holder 10. The holder 10 not only which supports the heater 14 but also on which the stay 11 is provided is inserted into a hollow portion of the film 8.

The heater 14 includes a thin elongated ceramic-made substrate 14a extending along the direction Y. On a surface of the substrate 14a on the pressing roller 9 side, a heat generating resistance layer 14b, such as silver-palladium generating heat by energization is provided along a longitudinal direction of the substrate 14a. The heat generating resistance layer 14b is coated with a glass coating as a protective layer 14c provided on the substrate 14a for ensuring protection and an insulating property of the heat generating resistance layer 14b.

The film 8 is a thin elongated member extending along the direction Y. As the film 8, a single layer film or a composite layer film is used. As the single layer film, a sleeve formed of a heat-resistant resin material is used. As the composite layer film, a film in which a sleeve obtained by subjecting an about 50 polyimide to heat-resistant treatment or by subjecting SUS or the like to a thin film process is used as a base layer and on a surface of the sleeve, a parting layer is formed of PTFE, PFA or the like.

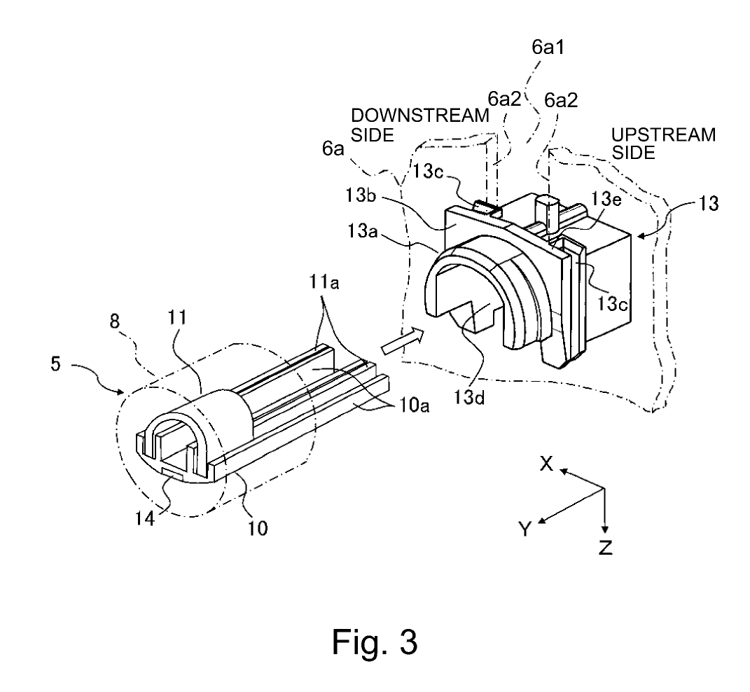

A structure of the flanges 13 will be described with reference to FIG. 3.

FIG. 3 is a perspective view showing the right-side flange 13 of FIG. 1. A left-side flange 13 has the same structure as the flange 13 of FIG. 3 and therefore will be omitted from detailed description.

The flange 13 is provided on both sides of the film 8 with respect to the longitudinal direction of the film 8. At side surfaces of the flange 13 on an upstream side and a downstream side with respect to the recording material feeding direction X of the flange 13, groove portions 13c are provided along the direction Z. On the other hand, a side plate 6a is provided with supporting portions 6a2 formed on an upstream side and a downstream side with respect to the recording material feeding direction X so that a recessed portion 6a1 is formed along the direction Z. Further, with respect to the direction Z, the groove portions 13c of the flange 13 are engaged with the supporting portions 6a2 of the side plate 6a, whereby the flange 13 is supported by the side plate 6a.

Further, the flange 13 includes a regulating (limiting) portion 13b for regulating (limiting) movement of the film 8 in the longitudinal direction with respect to the direction Y. Further, the flange 13 includes a supporting portion 13a for supporting an end portion of the film 8 and a hole 13d for supporting an end portion of the heating unit 5.

The regulating portion 13b is formed in a shape larger than an outer diameter with respect to the direction Y. As a result, an end surface 8a of the film 8 is capable of abutting against the regulating portion 13b.

With respect to the direction X, the supporting portion 13a is provided at a substantially central portion of the regulating portion 13b. The supporting portion 13a projects toward the film end surface 8a in the direction Y. This supporting portion 13a is formed in a semicircular (arcuate) shape capable of being inserted into the hollow portion of the film 8.

Inside the supporting portion 13a, the hole 13d is provided along the direction Y. This hole 13d penetrates the regulating portion 13b. In this hole 31d, end portions 10a and 11a of the guide 10 for the heating unit 5 and of the stay 11 are inserted and engaged, whereby the heating unit 5 is supported by the flange 13.

The fixing device 31 includes, as shown in FIG. 1, a pressing plate 12 swingable relative to the flange 13 in the direction Z. The pressing plate 12 is press-contacted to a surface-to-be-pressed 13e (FIG. 3) of the flange 13 by a pressing force of a pressing spring 7 locked to the side plate 6a, whereby the flange 13 is pressed in the direction Z.

As shown in FIG. 2, the flange 13 pressed in the direction Z presses the holder 10 through the stay 11. The holder 10 presses a protective layer 14c of the holder 10 toward an inner peripheral surface (inner surface), and further causes the outer peripheral surface of the film 8 to press-contact an outer peripheral surface of the pressing roller 9. As a result, the elastic layer 9b of the pressing roller 9 is depressed and elastically deformed, so that a nip N having a predetermined width with respect to the direction X is formed by the film 8 surface and the pressing roller 9 surface.

### (2-2) Heat Fixing Process Operation

As shown in FIG. 1, a gear 15 provided at one end portion of the core metal 9a of the pressing roller 9 is rotationally driven in an arrow direction by a motor (not shown). Then, the pressing roller 9 is rotated in an arrow direction shown in FIG. 2, and the film 8 is rotated in an arrow direction shown in FIG. 2 by rotation of the pressing roller 9.

When electric power is supplied from an unshown power (voltage) source to the heat generating resistance layer 14b of the heater 14, the heat generating resistance layer 14b generates heat, so that the heater 14 is abruptly increased in temperature. A temperature controller (not shown) acquires a heater temperature detected by a thermistor 15 (FIG. 2) as a temperature detecting member and controls electric power supplied to the heat generating resistance layer 14b so as to maintain the heater temperature at a predetermined fixing temperature (target temperature).

The recording material P carrying an unfixed toner image T thereon is heated while being fed through the nip N, whereby the toner image is fixed on the recording material P.

### (2-3) Supporting Portion 13a of Flange 13

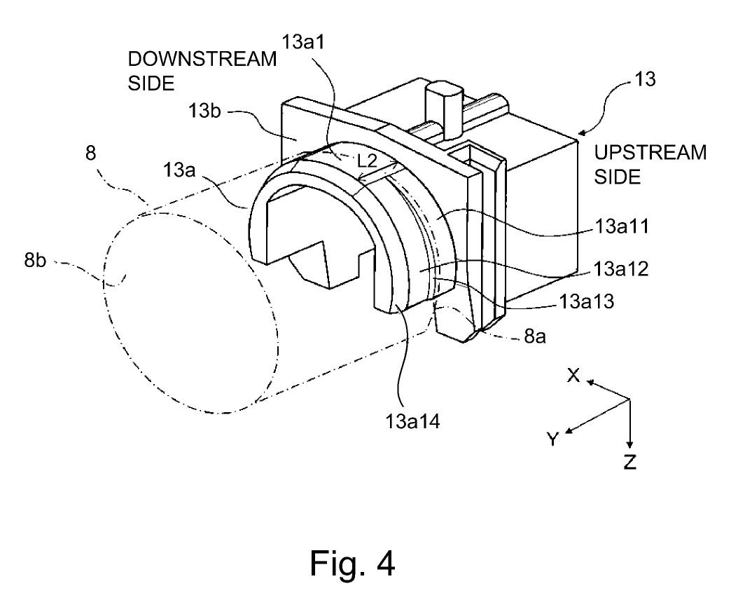

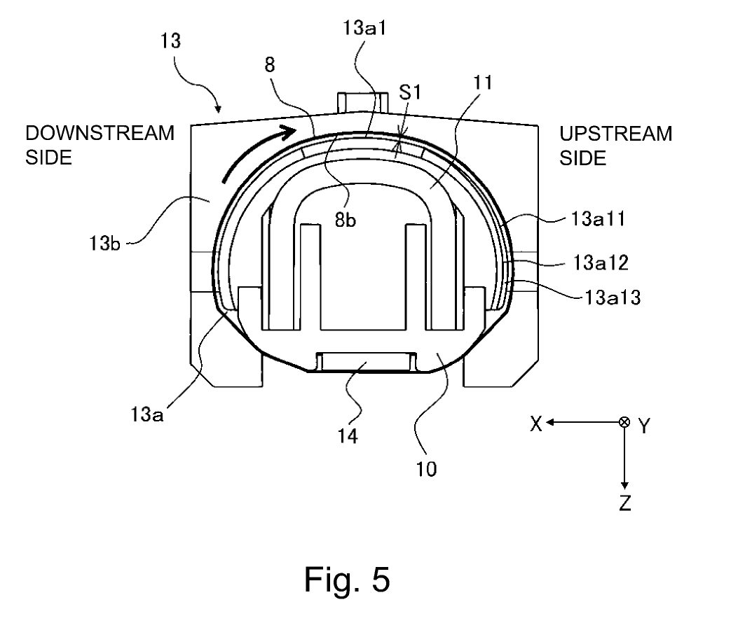

The supporting portion 13a of the flange 13 will be described with reference to FIGS. 4 and 5.

FIG. 4 is a perspective view when the right-side flange 13 of FIG. 1 and a right-side end portion of the film 8 supported by the supporting portion 13a of this flange 13 are seen from an upstream side of the recording material feeding direction.

FIG. 5 is a schematic view showing a positional relationship between the supporting portion 13a of the right-side flange 13 of FIG. 1 and the film 8 regulated in rotation orbit by the supporting portion 13a.

As shown in FIG. 4, the supporting portion 13a of the flange 13 includes an opposing surface 13a1 at a periphery of the supporting portion 13a. The opposing surface 13a1 is formed in a semicircular shape with respect to a circumferential direction of the film 8 so that the film 8 can smoothly rotate. A film inner surface 8b is slid on this opposing surface 13a1, whereby the rotation orbit of the film 8 is regulated.

Due to a component tolerance and an assembling tolerance in manufacturing of the device, when a gap between the film inner surface 8b and the opposing surface 13a1 of the supporting portion 13a decreases or when a peripheral length of the opposing surface 13a1 is longer than a film inner peripheral length, a sliding resistance of the film inner surface 8b relative to the opposing surface 13a1 increases. Then, there is a liability that a film slip such that the film 8 slips on the pressing roller 9 and film torsion due to a rotational speed difference between an end portion and a central portion of the film 8 generate. For that reason, as shown in FIG. 5, between the film inner surface 8b and the opposing surface 13a1, a proper gap S1 set by taking the component tolerance and the assembling tolerance in manufacturing of the device into consideration is ensured so as not to prevent rotation of the film 8.

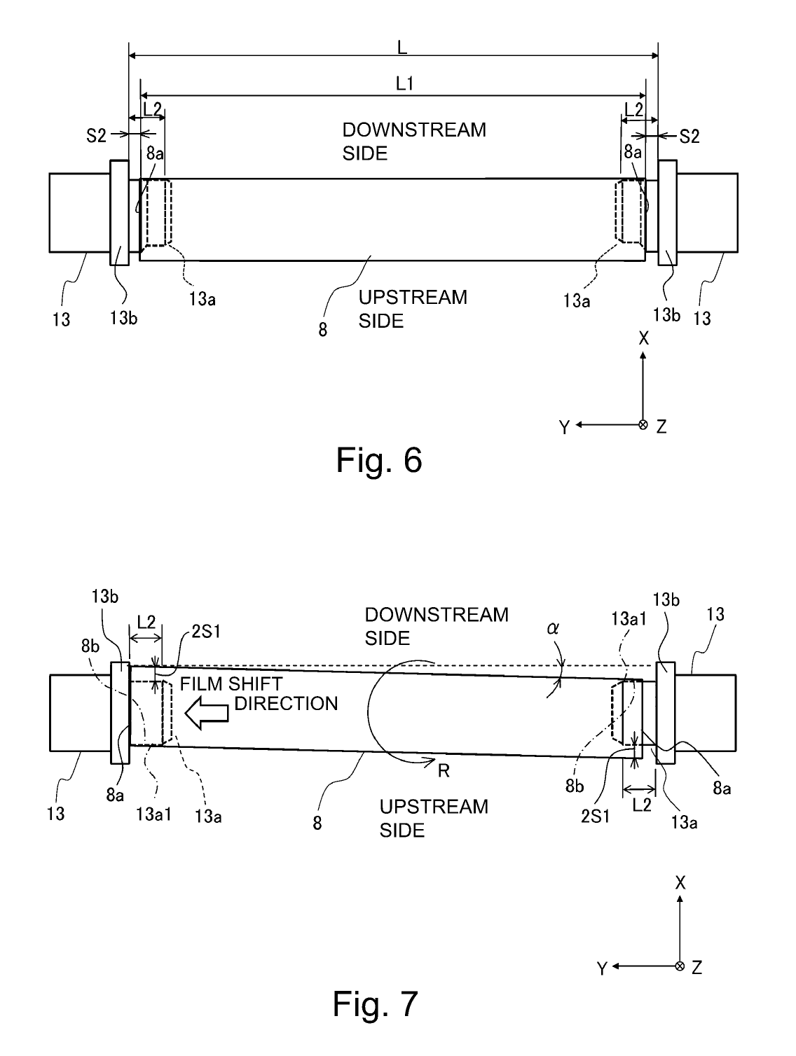

Next, a relationship between a length L1 of the film 8 and a distance L between the regulating portions 13b of the left and right flanges 13 will be described with reference to FIG. 6.

FIG. 6 is a schematic view showing the relationship between the length L1 of the film 8 and the distance L between the regulating portions 13b of the left and right flanges 13.

In the case where a shift (shift movement) of the film 8 generates, the film end surface 8a runs against the regulating portion 13b of the flange 13, whereby the shift of the film 8 is regulated (limited). When the distance L between the regulating portions 13b of the left and right flanges 13 is smaller than the length L1 due to the component tolerance and the assembling tolerance in manufacturing of the device, the regulating portion 13b and the film end surface 8a interfere with each other, so that buckling generates at the film end portion. For that reason, L is set so as to be larger than L1 in consideration of the tolerances of component parts constituting the left and right flanges 13 and the heating unit 5 and thermal expansion of the film 8.

Accordingly, with respect to the direction Y, between each of the regulating portions 13b of the left and right flanges 13 and an associated one of the film end surfaces 8a, a gap S2 varying depending on the above-described tolerances and the thermal expansion of the film 8 exists. That is, the film 8 is movable in the film longitudinal direction correspondingly to the gap S2. For that reason, as shown in FIGS. 4 and 6, a length L2 of the opposing surface 13a1 of the supporting portion 13a is a length (L2>S2) such that the above-described tolerances and the thermal expansion of the film 8 are taken into consideration and the film 8 is prevented from falling out of the supporting portion 13a with respect to the film longitudinal direction.

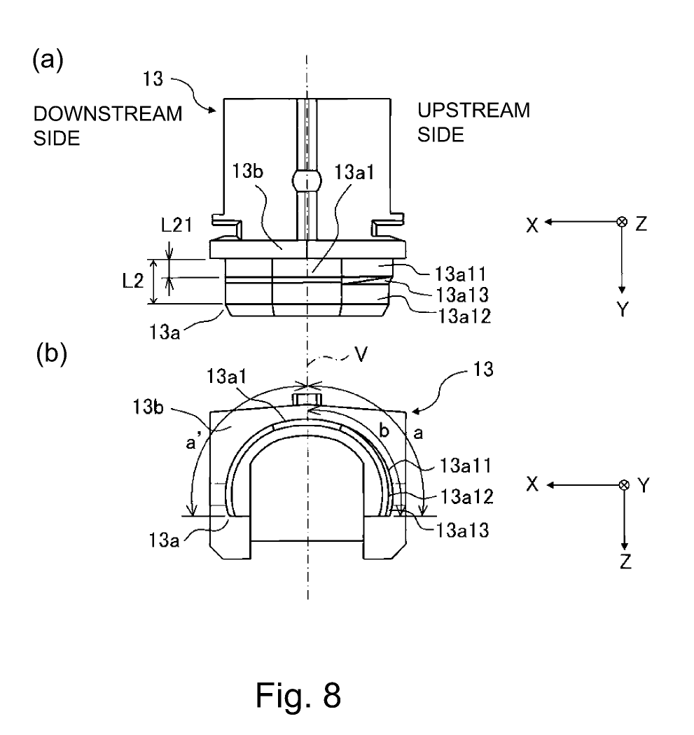

Here, a generation mechanism of generation of a shift of the film 8 will be described while making reference to FIG. 7 (Comparison Example 1).

FIG. 7 is a schematic view showing a state when the shift of the film 8 generates. In FIG. 7, a positional relationship between the film 8 and each of the left and right flanges 13. In FIG. 7, R is a rotational direction of the film 8.

When the pressing roller 9 and the film 8 rotate, the pressing roller 9 and the film 8 are not always parallel to each other, but have a crossing angle due to the above-described tolerances in some cases. further, even when the pressing roller 9 and the film 8 are parallel to each other, there are also cases where a difference in pressing force generates between the left and right pressing springs 7 and where a difference in rotational speed generates between left and right end portions of the film 8 depending on an attitude of the recording material P fed to the nip N.

In such cases, as shown in FIG. 7, the inner surface 8b of the right-side film end portion contacts a downstream regulating of the opposing surface 13a1 of the right-side flange 13 with respect to the direction X in some instances. Then, on the right end portion side of the film 8, the film 8 inclines toward the upstream side correspondingly to a gap 2S1 corresponding to twice the gap S1.

When the film 8 inclines toward the right end portion side, during rotation of the film 8 by the pressing roller 9, a force (film shifting force) for moving the film 8 toward the left-side flange 13 in the film longitudinal direction acts on the film 8, so that the shift of the film 8 generates. At this time, the film shifting force becomes larger with an increasing degree of inclination of the film 8.

The film 8 is shifted toward the left-side flange 13 by the film 8 shifting force, so that the film end surface 8a abuts against the regulating portion 13b. At this time, the film inner surface 8b slides on an upstream regulating of the opposing surface 13a1 of the supporting portion 13a of the flange 13 on the film shifting direction side with respect to the direction X. As a result, on the downstream side with respect to the recording material feeding direction, between the opposing surface 13a1 and the film inner surface 8b, a gap 2S1 corresponding to twice the gap S1 generates. As a result, the film 8 inclines toward the upstream side with respect to the recording material feeding direction so that the right end portion side of the film 8 inclines relative to the left end portion side of the film 8 by an angle α.

(2-4) Opposing Surfaces of Supporting Portion 13a on Upstream Side with Respect to Recording Material Feeding Direction

Opposing surfaces 13a11 and 13a12 of the supporting portion 13a on the upstream side with respect to the recording material feeding direction will be described with reference to FIG. 8.

Part (a) of FIG. 8 is a schematic view when the flange 13 is seen from a side opposite from the pressing roller 9, and part (b) of FIG. 8 is a schematic view when the flange 13 is seen from an outside thereof with respect to the film longitudinal direction. In parts (a) and (b) of FIG. 8, V represents a phantom perpendicular plane (phantom plane) perpendicular to a center of an a nip N with respect to the recording material feeding direction X.

As described above, in order to reduce the film shifting force by decreasing the degree of inclination of the film 8, there is a need to decrease the gap S1 between the film inner surface 8b and the opposing surface 13a1 of the supporting portion 13a of the flange 13.

However, when a peripheral length of the supporting portion 13a in a regulating of the opposing surface 13a1 is set at a large value and as a result the gap S1 is further decreased due to the above-described tolerances, a contact pressure between the film inner surface 8b and the opposing surface 13a1 when the film 8 rotates becomes high. Further, with respect to the direction Y, with a longer regulating in which the contact pressure between the film inner surface 8b and the opposing surface 13a1 becomes high, the film 8 is harder to rotates, so that a risk of generations of the film slip, the film torsion, and the like becomes large.

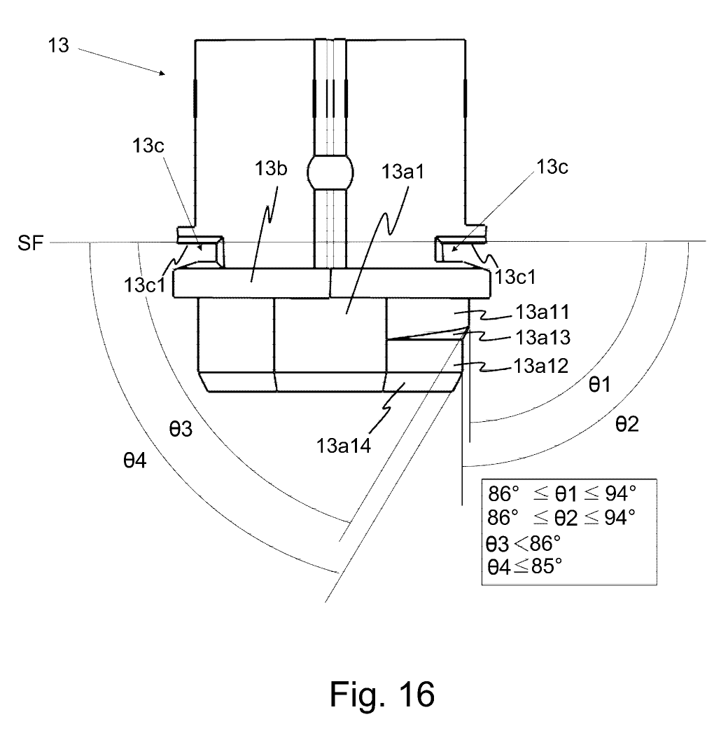

As shown in parts (a) and (b) of FIG. 8, the opposing surface 13a1 of the supporting portion 13a includes a first opposing surface 13a11 and a second opposing surface 13a12 as two or more opposing surfaces different in length of arc on the side upstream of the phantom plane V with respect to the recording material feeding direction X. As shown in FIG. 16, the first opposing surface 13a11 and the second opposing surface 13a12 are surfaces forming substantially right angles θ1 and θ2, respectively, with an engaging surface 13a1 which is a surface where the component part 13 engages with the frame 6 and which is a surface where the component part 13 opposes a flat surface portion of the frame 6. Specifically, the first opposing surface 13a11 and the second opposing surface 13a12 are surfaces forming the angles θ1 and θ2 with the engaging surface 13c1 each in arrange of 86° or more and 94° or less. Incidentally, a plane SF is a phantom plane along which the engaging surfaces 13c1 are extended.

With respect to the direction Y, the first opposing surface 13a11 is provided at a position close to the regulating portion 13b, and the second opposing surface 13a12 is provided at a position remote from the regulating portion 13b. The first opposing surface 13a11 close to the regulating portion 13b is longer in peripheral length extending along the inner surface 8b of the film 8 than the second opposing surface 13a12 remote from the regulating portion 13b. Each of these opposing surfaces 13a11 and 13a12 is a surface of regulating the rotation orbit of the film 8 in contact with the film inner surface 8b. Further, the peripheral length at the position where the first opposing surface 13a11 is provided is longer than the peripheral length at the position where the opposing surface 13a1 in Comparison Example 1 shown in FIG. 7 is provided, and the peripheral length at the position where the second opposing surface 13a12 is provided is not more than the peripheral length at the position where the opposing surface 13a1 in Comparison Example 1 shown in FIG. 7 is provided.

The first opposing surface 13a11 and the second opposing surface 13a12 will be further described specifically.

On the basis of the perpendicular plane V, a length of an arc of the first opposing surface 13a11 on the upstream side with respect to the direction X is a, and a length of an arc of the first opposing surface 13a11 on the downstream side with respect to the direction X is a′. In this embodiment, length a=length a′ holds. Further, on the basis of the perpendicular plane V, when a length of an arc of the second opposing surface 13a12 on the upstream side with respect to the direction X is b, the length b is made shorter than the length a. On the basis of the perpendicular plane V, the length of the arc of the first opposing surface 13a11 on the downstream side with respect to the direction X and a length of an arc of the second opposing surface 13a12 on the downstream side with respect to the direction X are the same (i.e., contours of these opposing surfaces on the downstream side with respect to the direction X are the same). Further, a length L21 of the first opposing surface 13a11 with respect to the direction Y is shorter than a total length L2 of the opposing surface 13a1 with respect to the direction Y. The total length L2 of the opposing surface 13a1 in this embodiment is equal to a total length L2 of the opposing surface 13a1 in Comparison Example 1 shown in FIG. 7. Accordingly, the flange 13 in this embodiment includes the first opposing surface 13a11 which is a regulating with the length L21 shorter than the total length L2 of the opposing surface 13a1 in Comparison Example 1 shown in FIG. 7 and which is a regulating with a contour larger than a contour of the opposing surface 13a1 in Comparison Example 1.

A stepped portion between the first opposing surface 13a11 and the second opposing surface 13a12 constitutes an inclined surface 13a13 smoothly connecting the first opposing surface 13a11 and the second opposing surface 13a12. A surface 13a14 is a tapered surface provided at an outer end of the supporting portion 13a. As shown in FIG. 16, an angle θ3 formed between the inclined surface 13a13 and the engaging surface 13a1 is smaller than 86°, and an angle θ4 formed between the tapered surface 13a14 and the engaging surface 13c1 is not more than 85°.

In the case where the film end surface 8s abuts against the regulating portion 13b of the flange 13, the film inner surface 8b slides with an upstream-side portion of the first opposing surface 13a11 with respect to the direction X. A sliding regulating is the regulating with the length L21. The surface shape of the first opposing surface 13a11 is an arcuate shape, and therefore, the film 8 smoothly rotates.

On the other hand, in the case where the film end surface 8a does not abut against either one of the regulating portions 13b of the left and right flanges 13, the film inner surface 8b slides on either one or both of the first opposing surface 13a11 and the second opposing surface 13a12. Regions where the rotation orbit of the film 8 is regulated by the first opposing surface 13a11 and the second opposing surface 13a12 change due to the above-described tolerances and the thermal expansion of the film 8. For that reason, also the surface shape of the second opposing surface 13a12 is an arcuate shape in which the film 8 can smoothly rotate.

Accordingly, the rotation orbit of the film 8 can also be regulated by the second opposing surface 13a12, and therefore, even when the length L21 of the first opposing surface 13a11 is made shorter than the length L2 necessary to prevent the film from falling out of the supporting portion 13a, it is possible to reduce degrees of the generations of the film slip and the film torsion.

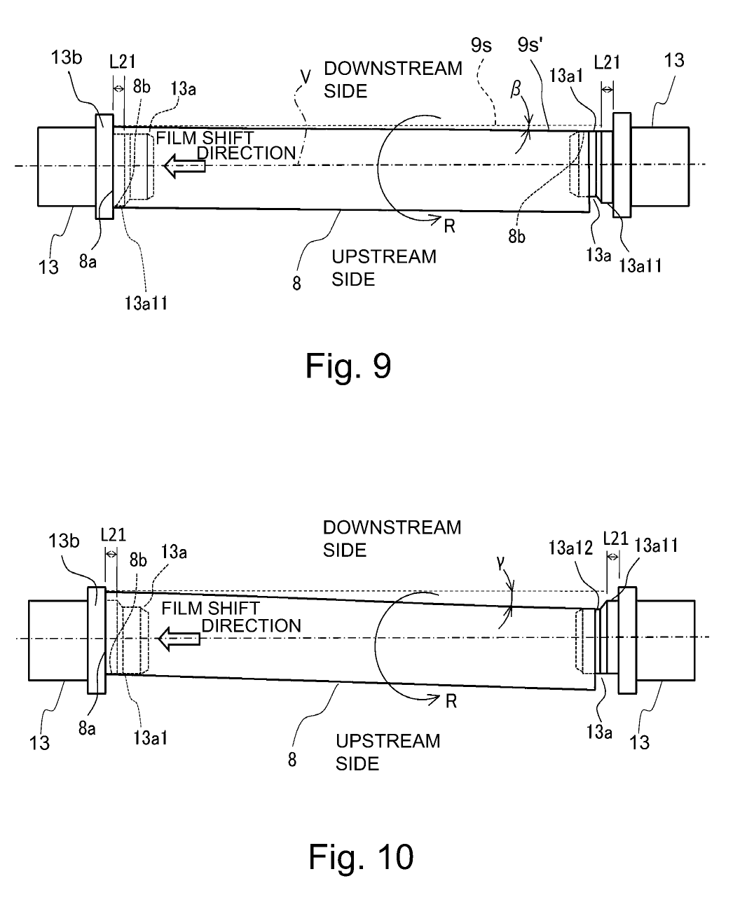

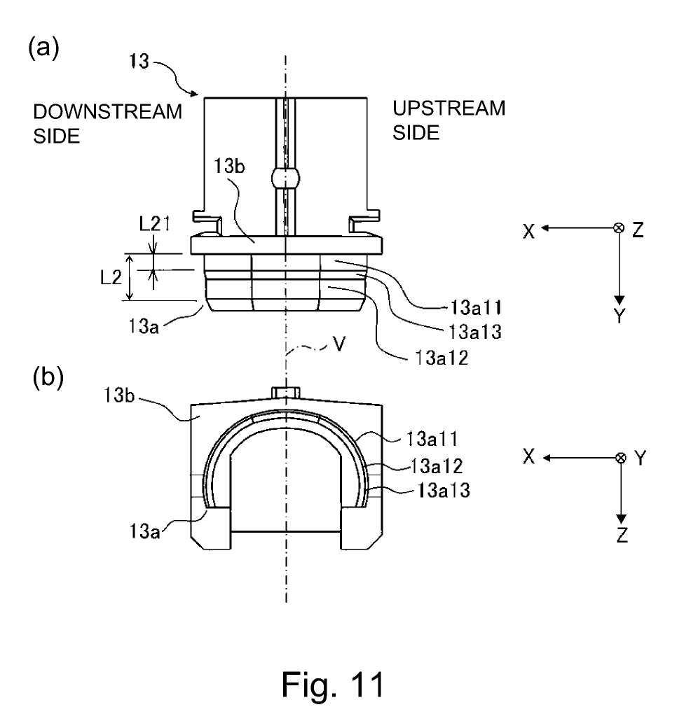

Next, the reason why the first opposing surface 13a11 and the second opposing surface 13a12 are provided will be described while making reference to FIG. 9 (Embodiment 1) and FIG. 10 (Comparison Example 2).

FIG. 9 is a schematic view showing the left and right flanges 13 each provided with the first opposing surface 13a11 and the second opposing surface 13a12 and showing the film 8. FIG. 10 is a schematic view showing a Comparison Example 2.

As shown in FIGS. 9 and 10, due to a variation in component part tolerance in manufacturing with respect to the film longitudinal direction of the film 8, the film 8 disconnects from the regulating of the first opposing surface 13a11 of the flange 13 on the opposite side from the film shifting direction, so that the rotation orbit of the film 8 cannot be regulated by this regulating in some instances.

As shown in FIG. 9, the film inner surface 8b slides on the opposing surface 13a1 of the supporting portion 13a of the flange (right-side flange) 13 on the opposite side from the film shifting direction, the rotation orbit of the film 8 cannot be regulated by the first opposing surface 13a11. In that case, the film end surface 8a of the film 8 abuts against the regulating portion 13b of the flange (left-side flange) 13 on the side where the film 8 shifted, so that the film inner surface 8b slides on the first opposing surface 13a11 (of the left-side flange) 13 in FIG. 9. As described above, the contour of the first opposing surface 13a11 is larger than the opposing surface 13a1 in Comparison Example 1. As a result, the film 8 inclines so that the right end portion side of the film 8 inclines toward the upstream side with respect to the recording material feeding direction with an angle β (<α) relative to the left end portion side of the film 8.

Further, as in Comparison Example 2 shown in FIG. 10, in the case where the portion increased in contour is provided on the downstream side with respect to the recording material feeding direction, the film 8 inclines so that the right end portion side of the film 8 inclines toward the upstream side with respect to the recording material feeding direction with an angle γ relative to the left end portion side of the film 8.

When the angles β and γ of FIGS. 9 and 10 are compared with each other, the angle β is smaller than the angle γ. Therefore, in the case where the first opposing surface 13a11 of the flange 13 is provided on the upstream side with respect to the recording material feeding direction, the film shifting force can be reduced compared with the case where the first opposing surface 13a11 is provided on the downstream side with respect to the recording material feeding direction.

In the fixing device 31 of this embodiment, when the shift of the film 8 generates, the first opposing surface 13a11 with the large contour regulates the rotation orbit of the film 8. For that reason, an inclination angle of the film 8 can be decreased, so that the shifting force of the film 8 can be reduced and thus breakage of the film end portion can be suppressed. Further, the length L21 of the first opposing surface 13a11 is short, and even when the contour at this portion is increased, a rotation resistance of the film 8 can be suppressed. Further, the second opposing surface 13a12 is provided, so that it is possible to prevent the film 8 from falling out of the flange 13.

### Embodiment 2

Another embodiment of the fixing device 31 will be described. In this embodiment, only a constitution different from the constitution of Embodiment 1 will be described.

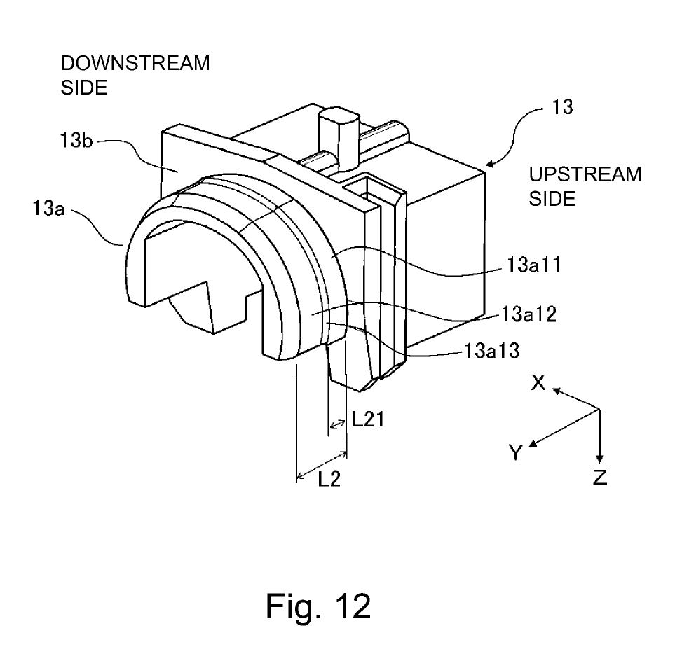

The fixing device 31 of this embodiment is shown in FIGS. 11 and 12. Part (a) of FIG. 11 is a schematic view when the flange 13 is seen from a side opposite from the pressing roller 9, and part (b) of FIG. 11 is a schematic view when the flange 13 is seen from an outside thereof with respect to the film longitudinal direction. FIG. 12 is a perspective view when the right-side flange 13 is seen from the upstream side with respect to the recording material feeding direction.

As shown in FIGS. 11 and 12, the flange 13 in this embodiment is provided with the first opposing surface 13a11 and the second opposing surface 13a12 at an entirety of the supporting portion 13a of the flange 13 with respect to a circumferential direction. A stepped portion between the first opposing surface 13a11 and the second opposing surface 13a12 constitutes the inclined surface 13a13 smoothly connecting the first opposing surface 13a11 and the second opposing surface 13a12.

The fixing device 31 according to this embodiment is capable of achieving an effect similar to that of Embodiment 1. Further, the shifting force of the film 8 can be reduced, so that similarly as in Embodiment 1, generation risks of the film slip and the film torsion can be reduced.

### Embodiment 3

Another embodiment of the fixing device 31 will be described. In this embodiment, only a constitution different from the constitution of Embodiment 1 will be described.

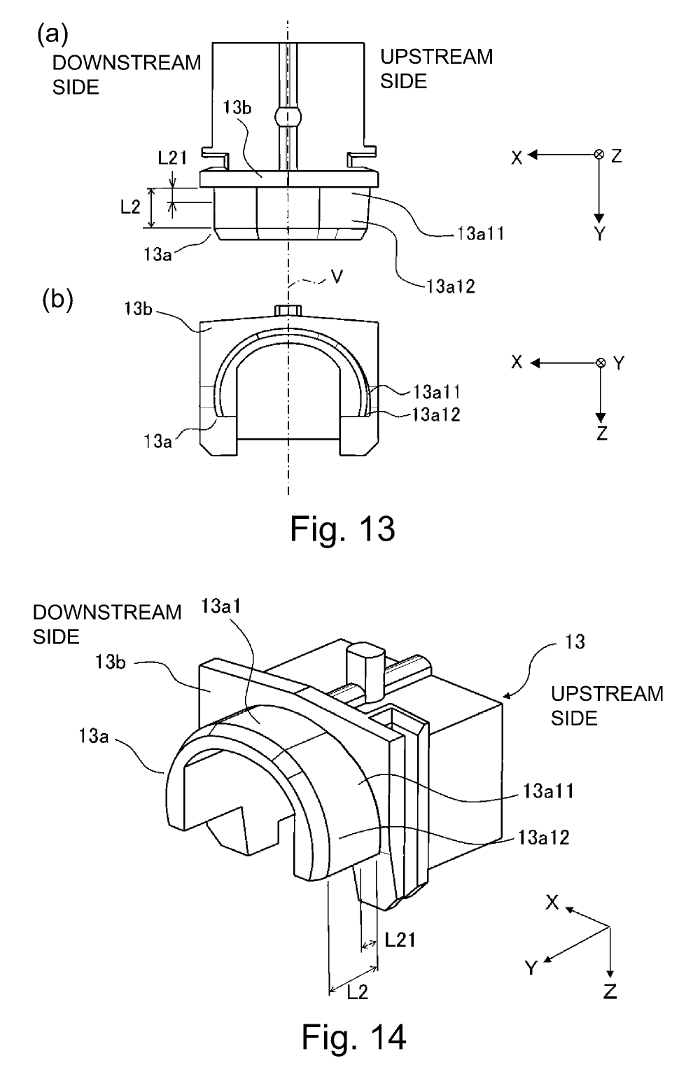

The fixing device 31 of this embodiment is shown in FIGS. 13 and 14. Part (a) of FIG. 13 is a schematic view when the flange 13 is seen from a side opposite from the pressing roller 9, and part (b) of FIG. 13 is a schematic view when the flange 13 is seen from an outside thereof with respect to a thrust direction of the film 8. FIG. 14 is a perspective view when the right-side flange 13 is seen from the upstream side with respect to the recording material feeding direction.

As shown in FIGS. 13 and 14, the flange 13 in this embodiment is provided with the first opposing surface 13a11 and the second opposing surface 13a12 on the upstream side of the supporting portion 13a of the flange 13 with respect to the recording material feeding direction. With respect to the longitudinal direction of the film 8, the first opposing surface 13a11 and the second opposing surface 13a12 constitutes a smoothly connected the inclined surface.

The fixing device 31 according to this embodiment is capable of achieving an effect similar to that of Embodiment 1.

### Another Embodiment

In the fixing devices 31 of Embodiments 1 to 3, each of the flanges 13 includes the two opposing surfaces 13a11 and 13a12 with respect to the longitudinal direction of the film 8, but may also include three or more opposing surfaces. For example, in the case where three opposing surfaces are provided, it is only required that contours of the opposing surfaces are made larger with a decreasing distance from the regulating portion 13.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2017-181186 filed on Sep. 21, 2017 and 2018-144753 filed on Aug. 1, 2018, which are hereby incorporated by reference herein in their entirety.

What is claimed is:

1. A fixing device for fixing an image formed on a recording material on the recording material, said fixing device comprising:
a frame;
a component part engaging with said frame;
a cylindrical film rotatable while being contactable to the recording material;
a supporting portion provided in an inside space of said film at a position opposing a longitudinal end portion of said film, said supporting portion being provided as a part of said component part; and
a roller contacting an outer peripheral surface of said film and configured to form a nip, in which the recording material is nipped and fed, between itself and said film,
wherein said supporting portion includes a first opposing surface opposing an inner surface of said film at the longitudinal end portion of said film and a second opposing surface opposing the inner surface of said film on an inside of said first opposing surface with respect to a longitudinal direction of said film,
wherein each of said first opposing surface and said second opposing surface is a surface forming a substantially right angle with an engaging surface which is a surface where said component part engages with said frame and where said component part opposes a flat surface portion of said frame, and
wherein when said component part is seen in the longitudinal direction of said film, a contour of said first opposing surface is larger than a contour of said second opposing surface.

2. A fixing device according to claim 1, wherein each of said first opposing surface and said second opposing surface has the substantially right angle falling in a range of 86° or more and 94° or less.

3. A fixing device according to claim 1, wherein said first and second opposing surfaces different in contour are provided only on a side upstream of said supporting portion on the basis of a phantom plane perpendicular to a center of the nip with respect to a recording material feeding direction.

4. A fixing device according to claim 1, wherein said first and second opposing surfaces different in contour are provided on both sides upstream and downstream of said supporting portion on the basis of a phantom plane perpendicular to a center of the nip with respect to a recording material feeding direction.

5. A fixing device according to claim 1, wherein between said first and second opposing surfaces, an inclined surface is provided.

6. A fixing device according to claim 1, wherein said component part includes a regulating surface against which an end surface of said film runs when said film shifts in the longitudinal direction.

7. A fixing device according to claim 1, further includes a heater contacting the inner surface of said film.

8. A fixing device according to claim 7, wherein the nip is formed between said film and said roller by said heater and said roller.
